(19) United States
(12) Patent Application Publication
(10) Pub. No.: US 2026/0214606 A1
(43) Pub. Date: Jul. 23, 2026

(54) DOWNLINK REFERENCE TIMING DETERMINATION FOR A MULTIPLE TRANSMISSION AND RECEPTION POINT CANDIDATE CELL IN LAYER 1 OR LAYER 2 BASED MOBILITY

(71) Applicant: QUALCOMM INCORPORATED, San Diego, CA (US)

(72) Inventors: Fang YUAN, Beijing (CN); Yan ZHOU, San Diego, CA (US)

(21) Appl. No.: 19/133,473

(22) PCT Filed: Jan. 20, 2023
(86) PCT No.: PCT/CN2023/073376

§ 371 Date: May 28, 2025

(51) Int. Cl. H04W 56/00

(52) U.S. Cl. CPC H04W 56/0045

(57) ABSTRACT

Various aspects of the present disclosure generally relate to wireless communication. In some aspects, a user equipment (UE) may receive a configuration indicating a plurality of downlink (DL) reference timings associated with timing advance (TA) management for a multiple transmission and reception point (mTRP) candidate cell. The UE may derive the plurality of DL reference timings based at least in part on the configuration. Numerous other aspects are described.

### FIELD OF THE DISCLOSURE

Aspects of the present disclosure generally relate to wireless communication and to techniques and apparatuses for downlink (DL) reference timing determination for a multiple transmission and reception point (mTRP) candidate cell in layer 1 (L1) or layer 2 (L2) based mobility.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration indicating a plurality of downlink (DL) reference timings associated with timing advance (TA) management for a multiple transmission and reception point (mTRP) candidate cell. The method may include deriving the plurality of DL reference timings based at least in part on the configuration.

Some aspects described herein relate to a UE for wireless communication. The user equipment may include a memory and one or more processors coupled to the memory. The one or more processors may be configured to receive a configuration indicating a plurality of DL reference timings associated with TA management for an mTRP candidate cell. The one or more processors may be configured to derive the plurality of DL reference timings based at least in part on the configuration.

Some aspects described herein relate to a non-transitory computer-readable medium that stores a set of instructions for wireless communication by a UE. The set of instructions, when executed by one or more processors of the UE, may cause the UE to receive a configuration indicating a plurality of DL reference timings associated with TA management for an mTRP candidate cell. The set of instructions, when executed by one or more processors of the UE, may cause the UE to derive the plurality of DL reference timings based at least in part on the configuration.

Some aspects described herein relate to an apparatus for wireless communication. The apparatus may include means for receiving a configuration indicating a plurality of DL reference timings associated with TA management for mTRP candidate cell. The apparatus may include means for deriving the plurality of DL reference timings based at least in part on the configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example logical architecture of a distributed radio access network (RAN), in accordance with the present disclosure.

FIG. 5 is a diagram illustrating an example of multiple transmission and reception point (mTRP) communication, in accordance with the present disclosure.

FIGS. 6A and 6B are diagrams illustrating examples of layer 1(L1)/layer 2 (L 2) inter-cell mobility, in accordance with the present disclosure.

FIG. 7 is a diagram illustrating an example associated with downlink (DL) reference timing determination for an mTRP candidate cell in layer 1 (L1) or layer 2 (L2) based mobility, in accordance with the present disclosure.

FIG. 8 is a diagram illustrating an example process performed, for example, by a UE, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G)

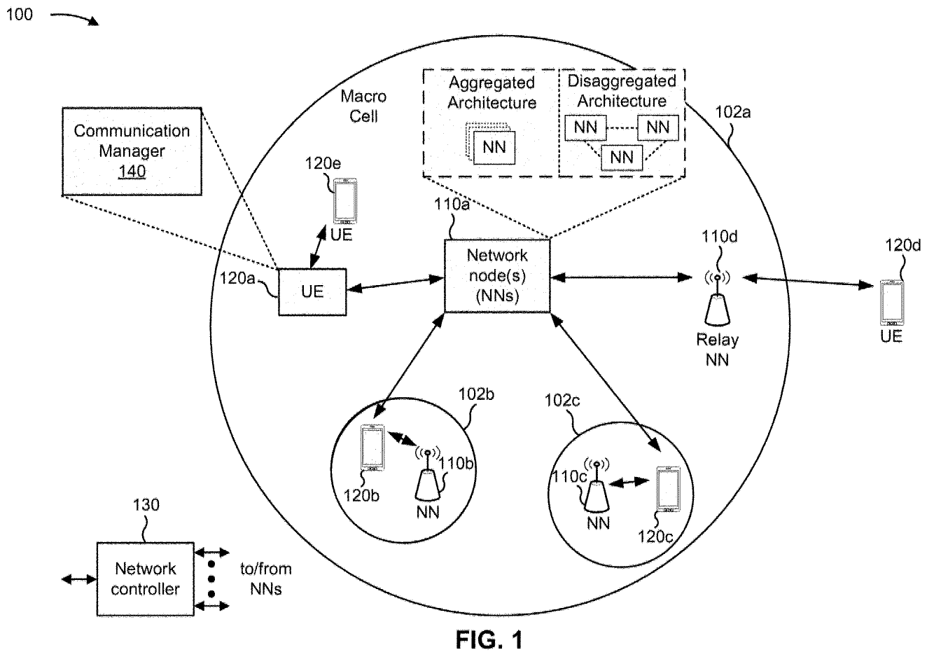

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration indicating a plurality of downlink (DL) reference timings associated with timing advance (TA) management for a multiple transmission and reception point (mTRP) candidate cell; and derive the plurality of DL reference timings based at least in part on the configuration. Additionally, or alternatively, the communication manager 140 may perform one or more other operations described herein.

As indicated above, FIG. 1 is provided as an example. Other examples may differ from what is described with regard to FIG. 1.

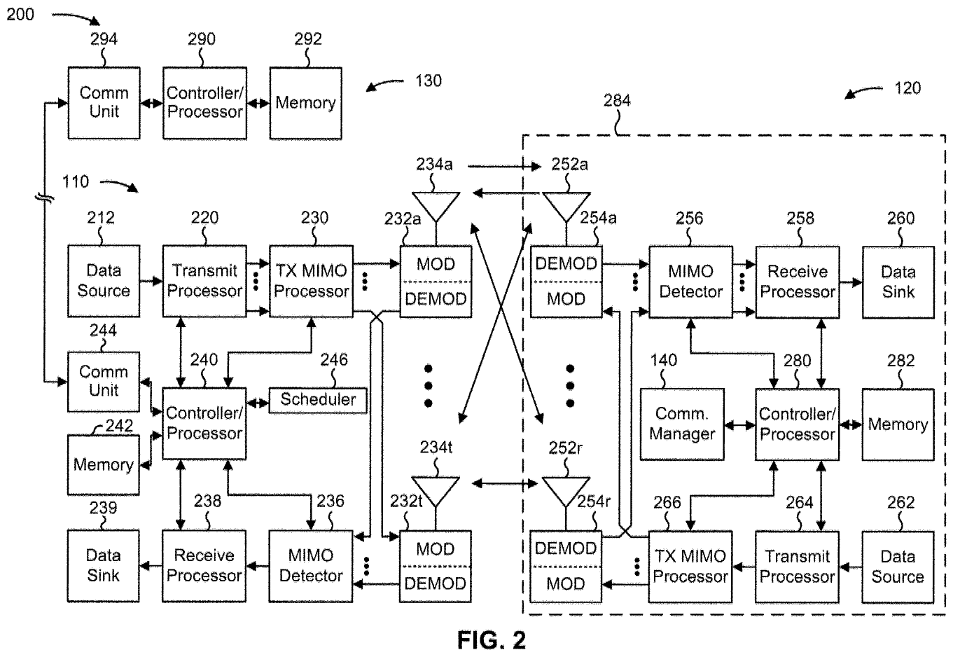

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

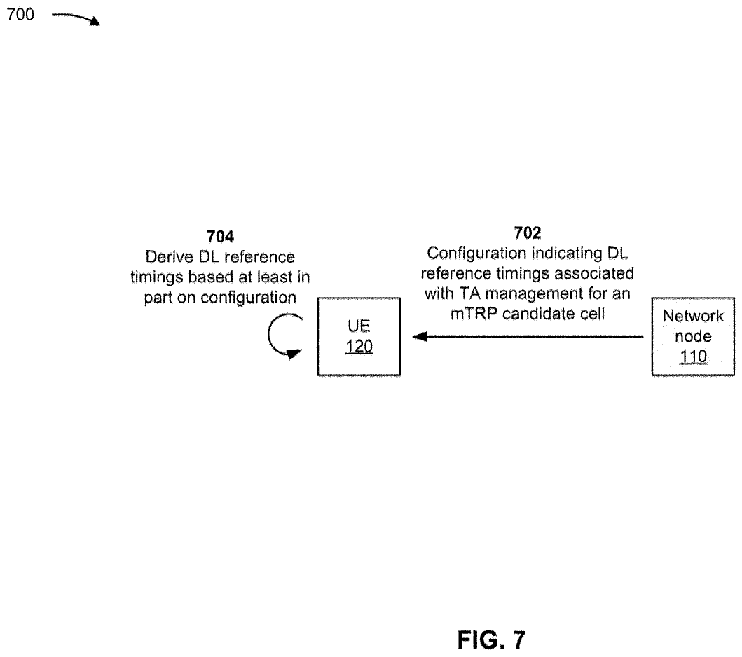

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-9).

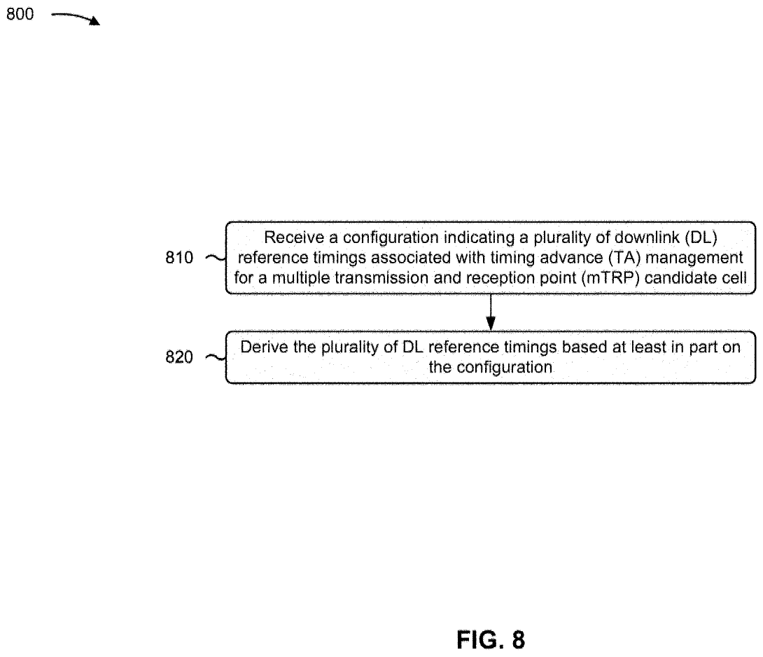

The controller/processor 240 of the network node 110, the controller/processor 280 of the UE 120, and/or any other component(s) of FIG. 2 may perform one or more techniques associated with DL reference timing determination for an mTRP candidate cell in layer 1 (L1) or layer 2 (L2) based mobility, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8 and/or other processes as described herein. In some examples, executing instructions may include running the instructions, converting the instructions, compiling the instructions, and/or interpreting the instructions, among other examples.

In some aspects, the UE 120 includes means for receiving a configuration indicating a plurality of DL reference timings associated with TA management for an mTRP candidate cell; and/or means for deriving the plurality of DL reference timings based at least in part on the configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

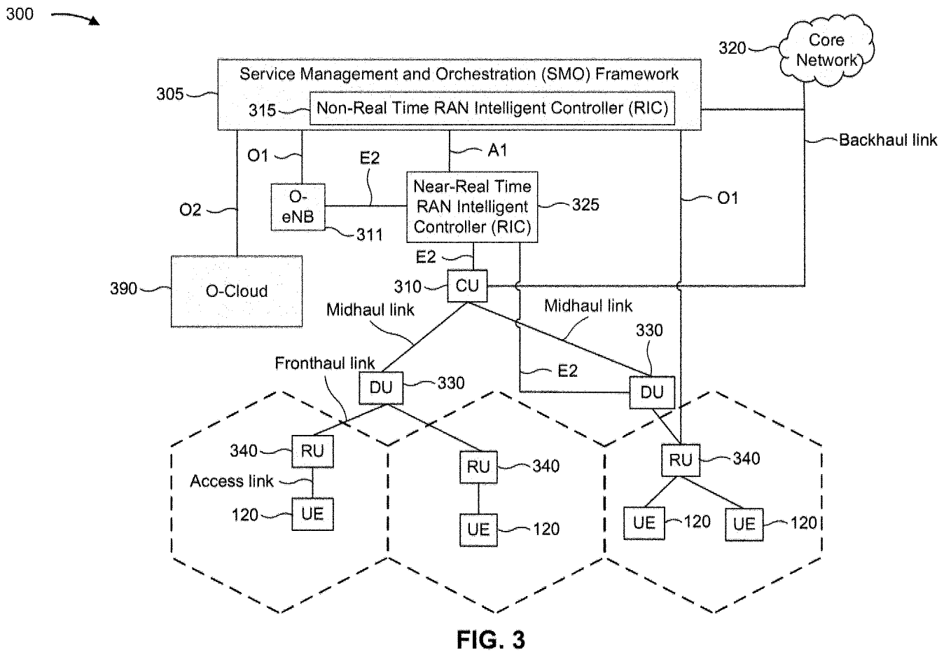

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325.

The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

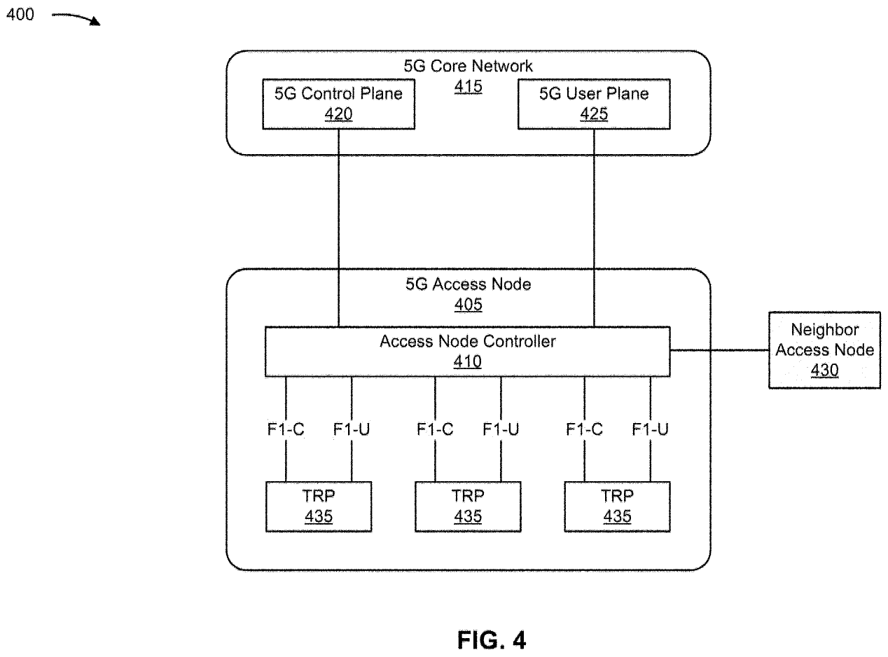

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may include a DU and/or an RU of the distributed RAN 400. In some aspects, a TRP 435 may correspond to a network node 110 described above in connection with FIG. 1. For example, different TRPs 435 may be included in different network nodes 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400, referred to elsewhere herein as a functional split. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

In some aspects, the techniques and apparatus described herein for DL reference timing determination for an mTRP candidate cell in L1 or L2 based mobility can be employed in a logical architecture such as that illustrated in FIG. 4.

As indicated above, FIG. 4 is provided as an example. Other examples may differ from what was described with regard to FIG. 4.

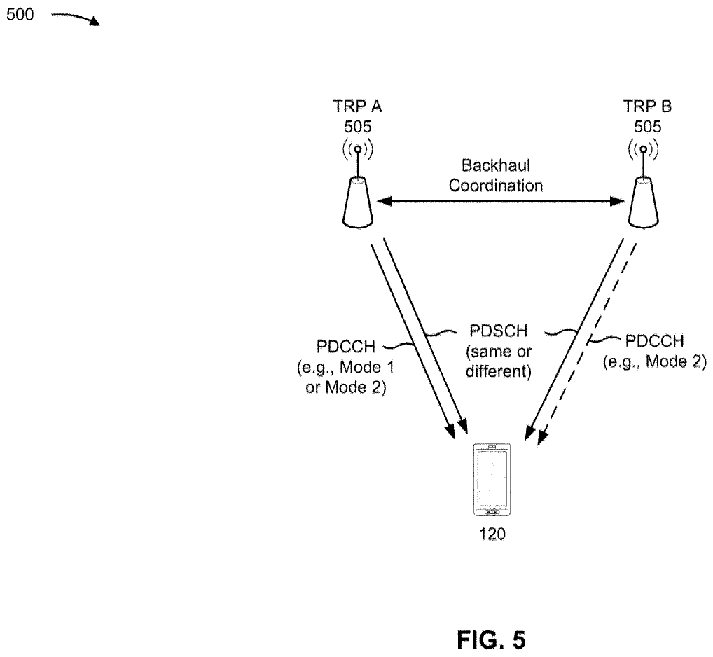

FIG. 5 is a diagram illustrating an example 500 of mTRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110), and may have a larger delay and/or lower capacity (as compared to co-location) when the TRPs 505 are located at different network nodes 110. The different TRPs 505 may communicate with the UE 120 using different QCL relationships (e.g., different TCI states), different DMRS ports, and/or different layers (e.g., of a multi-layer communication).

In a first mTRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for mTRP transmission as discussed here) in this mTRP transmission mode (e.g., Mode 1).

In a second mTRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

In some aspects, the techniques and apparatus described herein for DL reference timing determination for an mTRP candidate cell in L1 or L2 based mobility can be used to support mTRP communication as described with respect to FIG. 5.

As indicated above, FIG. 5 is provided as an example. Other examples may differ from what is described with respect to FIG. 5.

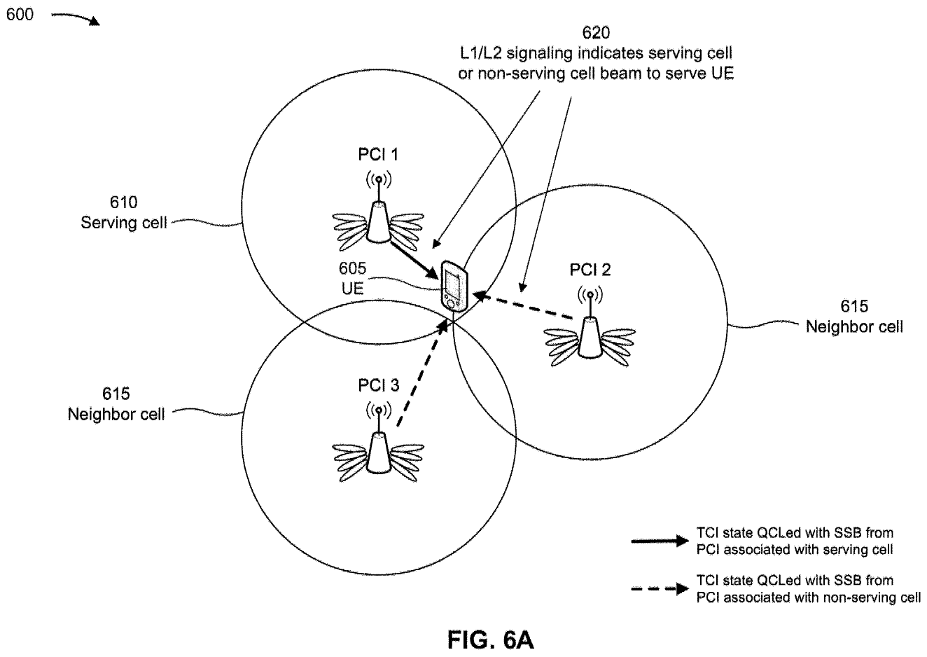

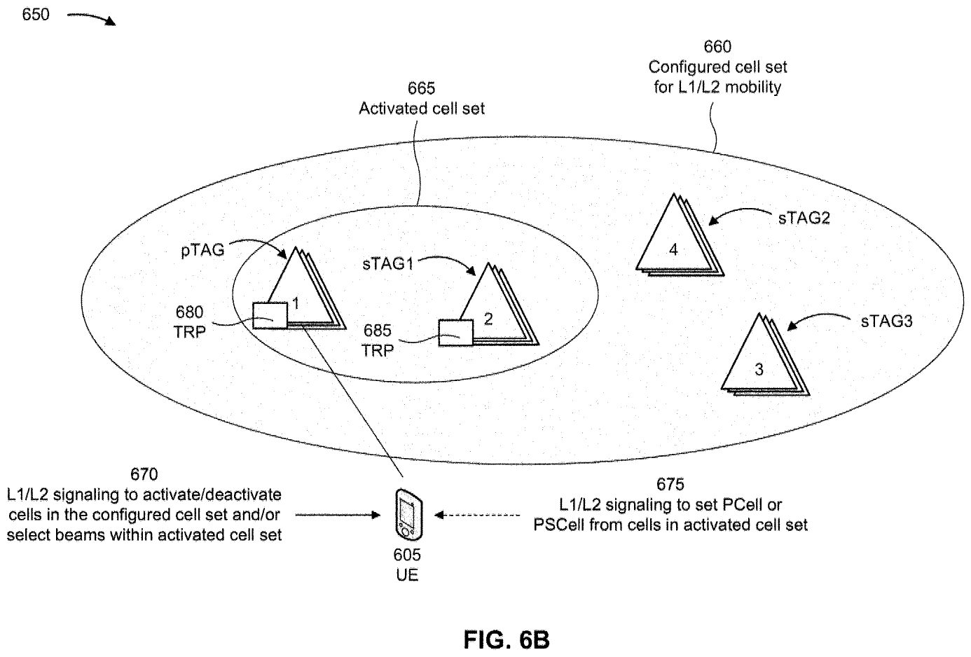

FIGS. 6A and 6B are diagrams illustrating examples 600, 650 of L1/L2 inter-cell mobility, in accordance with the present disclosure.

In a wireless network, such as an NR network, a UE and a network node (e.g., a base station or one or more units or components performing base station functionality) may communicate on an access link using directional links (e.g., using high-dimensional phased arrays) to benefit from a beamforming gain and/or to maintain acceptable communication quality. The directional links, however, typically require fine alignment of transmit and receive beams, which may be achieved through a set of operations referred to as beam management and/or beam selection, among other examples. Further, a wireless network may support multi-beam operation in a relatively high carrier frequency (e.g., within FR2), which may be associated with harsher propagation conditions than comparatively lower carrier frequencies.

For example, relative to a sub-6 gigahertz (GHz) band, signals propagating in a millimeter wave frequency band may suffer from increased pathloss and severe channel intermittency, and/or may be blocked by objects commonly present in an environment surrounding the UE (e.g., a building, a tree, and/or a body of a user, among other examples). Accordingly, beam management is particularly important for multi-beam operation in a relatively high carrier frequency.

One possible enhancement for multi-beam operation in a higher carrier frequency is facilitation of efficient (e.g., low latency and low overhead) downlink and/or uplink beam management to support higher L1/L2-centric inter-cell mobility. Accordingly, one goal for L1/L2-centric inter-cell mobility is to enable a UE to perform a cell switch via dynamic control signaling at lower layers (e.g., DCI for L1 signaling or a MAC control element (MAC CE) for L2 signaling) rather than semi-static Layer 3(L3) RRC signaling in order to reduce latency, reduce overhead, and/or otherwise increase efficiency of the cell switch.

For example, FIG. 6A illustrates an example 600 of a first L1/L2 inter-cell mobility technique, which may be referred to as inter-cell mobility scheme 1, beam-based inter-cell mobility, dynamic point selection based inter-cell mobility, and/or non-serving cell-based inter-cell mobility, among other examples. As described in further detail herein, the first L1/L2 inter-cell mobility technique may enable a network node to use L1 signaling (e.g., DCI) or L2 signaling (e.g., a MAC CE) to indicate that a UE 605 is to communicate on an access link using a beam from a serving cell or a non-serving cell. For example, in a wireless network where L1/L2 inter-cell mobility is not supported (e.g., cell switches are triggered only by an L3 handover), beam selection for control information and for data is typically limited to beams within a physical cell identifier (PCI) associated with a serving cell. In contrast, in a wireless network that supports the first L1/L2 inter-cell mobility technique (e.g., as shown in FIG. 6A), beam selection for control and data may be expanded to include any beams within a serving cell 610 or one or more non-serving neighbor cells 615 configured for L1/L2 inter-cell mobility.

For example, in the first L1/L2 inter-cell mobility technique shown in FIG. 6A, a UE 605 may be configured with a single serving cell 610, and the UE 605 may be further configured with a neighbor cell set that includes one or more non-serving neighbor cells 615 configured for L1/L2 inter-cell mobility. In general, the serving cell 610 and the non-serving neighbor cells 615 that are configured for L1/L2 inter-cell mobility may be associated with a common CU and a common DU, or the serving cell 610 and the non-serving neighbor cells 615 configured for L1/L2 inter-cell mobility may be associated with a common CU and different DUs. In some aspects, as shown by reference number 620, a network node may trigger L1/L2 inter-cell mobility for a UE using L1/L2 signaling (e.g., DCI or a MAC CE) that indicates a selected TCI state QCLed with a reference signal (e.g., a synchronization signal block (SSB)) associated with a PCI. For example, in FIG. 6A, the UE may be communicating with the serving cell 610 using a TCI state that is QCLed with an SSB from a PCI associated with the serving cell 610 (e.g., shown as PCI 1 in FIG. 6A), and L1/L2 signaling may trigger inter-cell mobility by indicating that the UE is to switch to communicating using a TCI state that is QCLed with an SSB from a PCI associated with a non-serving neighbor cell 615 (e.g., shown as PCI 2 in FIG. 6A). Accordingly, in the first L1/L2 inter-cell mobility technique, the network node (e.g., the common CU controlling the serving cell 610 and the non-serving neighbor cells 615) may use L1/L2 signaling to select a beam from either the serving cell 610 or a non-serving neighbor cell 615 to serve the UE 605.

In this way, relative to restricting L1/L2 beam selection to beams within the serving cell 610, the first L1/L2 inter-cell mobility technique may be more robust against blocking and may provide more opportunities for higher rank spatial division multiplexing across different cells. However, the first L1/L2 inter-cell mobility technique does not enable support for changing a primary cell (PCell) or a primary secondary cell (PSCell) for a UE 605. Rather, in the first L1/L2 inter-cell mobility technique, triggering a PCell or PSCell change is performed via a legacy L3 handover using RRC signaling. In this respect, the first L1/L2 inter-cell mobility technique is associated with a limitation that L1/L2 signaling can only be used to indicate a beam from the serving cell 610 or a configured neighbor cell 615 while the UE 605 is in the coverage area of the serving cell 610 because L1/L2 signaling cannot be used to change the PCell or PSCell. Accordingly, FIG. 6B illustrates an example 650 of a second L1/L2 inter-cell mobility technique, which may be referred to as inter-cell mobility scheme 2 and/or serving cell-based inter-cell mobility, among other examples. As described in further detail herein, the second L1/L2 inter-cell mobility technique may enable a network node to use L1/L2 signaling (e.g., DCI or a MAC CE) to indicate control information associated with an activated cell set and/or a deactivated cell set and/or to indicate a change to a PCell or a PSCell within the activated cell set.

For example, as shown in FIG. 6B, the second L1/L2 inter-cell mobility technique may use mechanisms that are generally similar to carrier aggregation to enable L1/L2 inter-cell mobility, except that different cells configured for L1/L2 inter-cell mobility may be on the same carrier frequency. As shown in FIG. 6B, a network node may configure a cell set 660 for L1/L2 inter-cell mobility (e.g., using RRC signaling) that includes at least a cell 1 (“1”), a cell 2 (“2”), a cell 3 (“3”), and a cell 4 (“4”). As further shown, an activated cell set 665 may include one or more cells in the configured cell set 660 that are activated and ready to use for data and/or control transfer. The activated cell set 665 may include cell 1 and cell 2, for example. Cell 1 may be a PCell and cell 2 may be a PSCell. Accordingly, in the second L1/L2 inter-cell mobility technique, a deactivated cell set may include one or more cells (cell 3 and cell 6) that are included in the cell set 660 configured for L1/L2 inter-cell mobility but are not included in the activated cell set 665. However, the cells that are included in the deactivated cell set can be readily activated, and thereby added to the activated cell set 665, using L1/L2 signaling. Accordingly, as shown by reference number 670, L1/L2 signaling can be used for mobility management of the activated cell set 665. For example, in some aspects, L1/L2 signaling can be used to activate cells within the configured cell set 660 (e.g., to add cells to the activated cell set 665), to deactivate cells in the activated cell set 665, and/or to select beams within the cells included in the activated cell set 665. In this way, the second L1/L2 inter-cell mobility technique may enable seamless mobility among the cells included in the activated cell set 665 using L1/L2 signaling (e.g., using beam management techniques).

Furthermore, as shown by reference number 675, the second L1/L2 inter-cell mobility technique enables using L1/L2 signaling to set or change a PCell or PSCell from the cells that are included in the activated cell set 665. Additionally, or alternatively, when the cell that is to become the new PCell or PSCell is in the deactivated cell set (e.g., is included in the cell set 660 configured for L1/L2 mobility but not the activated cell set 665), L1/L2 signaling can be used to move the cell from the deactivated cell set to the activated cell set 665 before further L1/L2 signaling is used to set the cell as the new PCell or PSCell. However, in the second L1/L2 inter-cell mobility technique, an L3 handover (using RRC signaling) is used to change the PCell or PSCell when the new PCell or PSCell is not included in the cell set 660 configured for L1/L2 inter-cell mobility. In such cases, RRC signaling associated with the L3 handover may be used to update the cells included in the cell set 660 that is configured for L1/L2 inter-cell mobility.

In some aspects, multiple TRPs 680 and 685 may transmit communications (for example, the same communication or different communications) in the same TTI (for example, a slot, a mini-slot, a subframe, or a symbol) or different TTIs using different QCL relationships (for example, different spatial parameters, different TCI states, different precoding parameters, or different beamforming parameters). In some aspects, a TCI state may be used to indicate one or more QCL relationships. A TRP 680 may be configured to individually (for example, using dynamic selection) or jointly (for example, using joint transmission with one or more other TRPs 685) serve traffic to a UE 605. In some aspects, the TRP 680 and/or the TRP 685 may be, include, or be included in, one or more network nodes 110 described above in connection with FIGS. 1 and 2. In some examples, different TRPs 680 and 685 may be included in different base stations and/or other network nodes. In some cases, multiple TRPs 680 and 685 may be included in a single base station and/or other network node. In some cases, a TRP 680 and/or a TRP 685 may be referred to as a network node, a cell, a panel, an antenna array, and/or an array.

The cells in the L1/L2 mobility configured cell set 660 can belong to timing advance groups (TAGs). “TAG” may refer to a group of cells that have the same (or similar within a threshold value) uplink TA values. For example, a first uplink carrier and a second uplink carrier may have different propagation delays between the UE 605 and the TRP 680 associated with cell 1 and between the UE 605 and the TRP 685. For example, the TRP 680 and the TRP 685 may not be co-located with one another, resulting in different propagation delays for uplink transmissions to reach a respective TRP on the different uplink carriers. As a result, the first uplink carrier and the second uplink carrier may have different timing advance values for uplink transmissions and may belong to different TAGs. The UE 605 may use a timing advance value for an uplink carrier to transmit an uplink communication on the uplink carrier with a timing that results in synchronization of TTIs with a TRP 680 or 685, to reduce inter-TTI interference.

In some aspects, the techniques and apparatus described herein for DL reference timing determination for an mTRP candidate cell can be used in support of L1/L2 inter-cell mobility as described with respect to FIGS. 6A and 6B.

As indicated above, FIGS. 6A and 6B are provided as examples. Other examples may differ from what is described with respect to FIGS. 6A and 6B.

As described above, wireless communication system may support L1 or L2 base mobility that allows a serving cell-which may be referred to as a special cell (SpCell)-to be updated via L1 or L2 signaling based on an L1 measurement. The SpCell may be, for example, a PCell of a master cell group (MCG) or a PSCell of a secondary cell group (SCG). In some systems, a UE may be configured with a set of candidate SpCells (referred to as a candidate SpCell set). In operation, L1 or L2 based mobility allows the SpCell of the UE to be changed from one SpCell in the candidate SpCell set to another SpCell in the candidate SpCell set. A cell in the candidate SpCell set to which the UE may switch is referred to herein as a candidate SpCell or, more generally, as a candidate cell.

Further, as described above, the wireless communication system may support multi-DCI mTRP operation with multiple (e.g., two) TAs in a component carrier. According to such operation, multiple (e.g., two) DL reference timings are supported, where each DL reference timing is associated with a respective TAG. Thus, for a given cell, a UE may configured for mTRP operation, and each TRP of the cell may be associated with a different TA. In operation, each TA is associated with a different DL reference timing, with each DL reference timing being defined by a channel or reference signal in the downlink.

Notably, the aspects related to DL reference timing management described above are applicable for active TRPs in mTRP operation. However, one or more candidate cells associated with providing L1 or L2 base mobility may be deactivated (i.e., not activated). Therefore, DL reference timing determination for an mTRP candidate cell in L1 or L2 based mobility should be defined.

Some techniques and apparatuses described herein enable DL reference timing determination for an mTRP candidate cell in L1 or L2 based mobility. In some aspects, a UE may receive configuration indicating a plurality of DL reference timings associated with TA management for an mTRP candidate cell. In some aspects, the UE 120 may derive the plurality of DL reference timings based at least in part on the configuration. In this way, DL reference timing determination for the mTRP candidate cell in L1 or L2 based mobility can be defined, thereby enabling L1 or L2 based mobility for a UE that configured for mTRP communication. Additional details are provided below.

As indicated above, FIG. 6 is provided as an example. Other examples may differ from what is described with respect to FIG. 6.

FIG. 7 is a diagram illustrating an example 700 associated with DL reference timing determination for an mTRP candidate cell in L1 or L2 based mobility, in accordance with the present disclosure. As shown in FIG. 7, example 700 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

In some aspects, the UE 120 may be configured for mTRP communication with a plurality of TRPs (e.g., a plurality of TRPs 505 supported by the network node 110 or one or more other network nodes 110). In some aspects, the UE 120 is configured with a set of mTRP candidate cells (e.g., a candidate SpCell set including one or more candidate SpCells), where each mTRP candidate cell is supported by two or more TRPs (e.g., two or more TRPs 505).

As shown by reference 702, the UE 120 may receive (e.g., from the network node 110) a configuration indicating a plurality of DL reference timings associated with TA management for an mTRP candidate cell. In some aspects, the mTRP candidate cell is a candidate SpCell included in the candidate SpCell set configured for the UE 120. In some aspects, the configuration indicates one or more DL reference timings that the UE 120 is to derive or maintain in order to provide TA management in support of L1 or L2 based mobility for the mTRP candidate cell. That is, the configuration may indicate a manner in which the UE 120 is to derive DL reference timings for each TRP associated with an mTRP candidate cell. In some aspects, the configuration indicates multiple pluralities of DL reference timings, each plurality of DL reference timings being associated with a different mTRP candidate cell from the set of mTRP candidate cells configured for the UE 120.

In some aspects, each DL reference timing of the plurality of DL reference timings corresponds to a different DL reference signal (RS) set. That is, in some aspects, the configuration may indicate a plurality of DL RS sets, where each DL reference timing of the plurality of DL reference timings corresponds to a respective DL RS set of a plurality of DL RS sets. Here, each DL RS set of the plurality of DL RS sets may be associated with a respective TRP of a plurality of TRPs associated with the mTRP candidate cell. Thus, the multiple DL reference timings may in some aspects correspond to different DL RS sets for different TRPs.

A DL RS set may be, for example, a SSB set. In some aspects, one or more DL RS sets of the plurality of DL RS sets may be configured via RRC signaling. Additionally, or alternatively, one or more DL RS set of the plurality of DL RS sets may be configured via a MAC CE. In some aspects, DL RS sets in the plurality of DL reference signal sets are grouped according to a predetermined rule. For example, a first subset of a set of SSBs (e.g., a lower half of the SSB set in the frequency domain) may be associated with a first TRP of the mTRP candidate cell and a second subset of the set of SSBs (e.g., a higher half of the SSB set in the frequency domain) may be associated with a second TRP of the mTRP candidate cell.

In some aspects, each DL reference timing of the plurality of DL reference timings corresponds to a different indicated TCI state. That is, in some aspects, the configuration may indicate a plurality of indicated TCI states, where each DL reference timing of the plurality of DL reference timings corresponds to a respective indicated TCI state of the plurality of indicated TCI states. Here, each indicated TCI state of the plurality of indicated TCI states may be associated with a respective TRP of a plurality of TRPs associated with the mTRP candidate cell. Thus, the multiple DL reference timings may in some aspects correspond to different indicated TCI states for different TRPs.

In some aspects, each DL reference timing of the plurality of DL reference timings corresponds to a different activated TCI state set. That is, in some aspects, the configuration may indicate a plurality of activated TCI state sets, where each DL reference timing of the plurality of DL reference timings corresponds to a respective activated TCI state set of the plurality of activated TCI state sets. Here, each activated TCI state set of the plurality of activated TCI state sets may be associated with a respective TRP of a plurality of TRPs associated with the mTRP candidate cell. Thus, the multiple DL reference timings may in some aspects correspond to different activated TCI state sets for different TRPs.

As shown by reference 704, the UE 120 may derive the plurality of DL reference timings based at least in part on the configuration. In some aspects, the UE 120 may derive the plurality of DL reference timings based at least in part on receiving a signal from each of the TRPs associated with the mTRP candidate cell. For example, the TRPs associated with the mTRP candidate cell may each transmit a signal associated with the configured DL reference timings. As a particular example, a given TRP may transmit a DL RS set (e.g., one or more SSBs), a QCL source RS of a particular QCL type (e.g., QCL type D, QCL type A, or the like) of an indicated TCI state of the TRP, or a QCL source RS of an activated TCI state set for the TRP. In some aspects, the UE 120 may receive the signal transmitted by the TRP and may derive an associated DL reference timing (e.g., based at least in part on the SSB set, the QCL source RS of the particular QCL type of the indicated TCI state, or the QCL source RS of the activated TCI state set).

In some aspects, a DL reference timing of the plurality of DL reference timings may be derived based at least in part on a particular arrival path associated with the signal, such as a first arrival path (e.g., a first-in-time arrival path) of the signal or a strongest arrival path (e.g., an arrival path with a highest received power) of the signal. For example, each DL reference timing of the plurality of DL reference timings may correspond to a different DL RS set, as described above. In this scenario, the UE 120 may derive a given DL reference timing based at least in part on a first arrival path or a strongest arrival path of a DL RS set to which the DL reference timing corresponds. As another example, each DL reference timing of the plurality of DL reference timings may correspond to a different indicated TCI state, as described above. In this scenario, the UE 120 may derive a given DL reference timing based at least in part on a first arrival path or a strongest arrival path of a QCL source RS of a particular QCL type (e.g., QCL type D, QCL type A, or the like) of an indicated TCI state to which the DL reference timing corresponds. As another example, each DL reference timing of the plurality of DL reference timings may correspond to a different activated TCI state set, as described above. In this scenario, the UE 120 may derive a given DL reference timing based at least in part on a first arrival path or a strongest arrival path of a QCL source RS of an activated TCI state set to which the DL reference timing corresponds.

In some aspects, the UE 120 may maintain one or more DL reference timings of the plurality of DL reference timings derived by the UE 120 for the mTRP candidate cell. In some aspects, to maintain a DL reference timing, the UE 120 derives the DL reference timing over time (e.g., on a periodic basis). Put another way, to maintain the at least one DL reference timing, the UE 120 may in some aspects repeatedly derive the DL reference timing (e.g., such that the UE 120 derives the DL reference timing on multiple occasions over time). In some aspects, maintaining the DL reference timing enables a TA associated with the DL reference timing to be updated or adjusted so as to improve accuracy of the TA over time (e.g., as channel conditions change).

In some aspects, the UE 120 may maintain the one or more DL reference timings based at least in part on an explicit indication to maintain the one or more DL reference timings. For example, the network node 110 may transmit, and the UE 120 may receive, a communication that explicitly indicates the one or more DL reference timings that are to be maintained by the UE 120. As one example, the explicit may indicate that the UE 120 is to maintain a single DL reference timing (e.g., a DL reference timing associated with a particular TRP). As another example, the explicit indication may indicate that the UE 120 is to maintain multiple DL reference timings (e.g., two DL reference timings, each associated with a different TRP). In some aspects, the UE 120 may maintain the one or more DL reference timings based at least in part on the explicit indication. In some aspects, the UE 120 may receive (e.g., from the network node 110) the explicit indication via, for example, RRC signaling, a MAC CE, or DCI.

In some aspects, the UE 120 may maintain the one or more DL reference timings based at least in part on an implicit indication to maintain the one or more DL reference timings. For example, the network node 110 may not explicitly indicate any DL reference timings to be maintained by the UE 120. In this example, the UE 120 is implicitly indicated to maintain one or more particular DL reference timings (i.e., the lack of explicit indication serves as the implicit indication). The one or more particular DL reference timings may include, for example, a DL reference timing associated with a default TRP of the mTRP candidate cell, such as a DL reference timing for a TRP associated with a lowest control resource set (CORESET) pool index value.

In some aspects, the UE 120 may transmit, and the network node 110 may receive, UE capability information that indicates a capability of the UE 120 with respect to maintaining one DL reference timing or maintaining multiple DL reference timings. Thus, in some aspects, the indication of the one or more DL reference timings to be maintained by the UE 120 may in some aspects be based at least in part on a capability of the UE 120 to maintain a single DL reference timing or to maintain multiple DL reference timings. In some aspects, the UE capability information may be indicated per serving cell. Additionally, or alternatively, the UE capability information may be indicated per frequency band. Additionally, or alternatively, the UE capability information may be indicated per frequency band combination.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with downlink reference timing determination for a multiple transmission and reception point candidate cell in layer 1 or layer 2 based mobility.

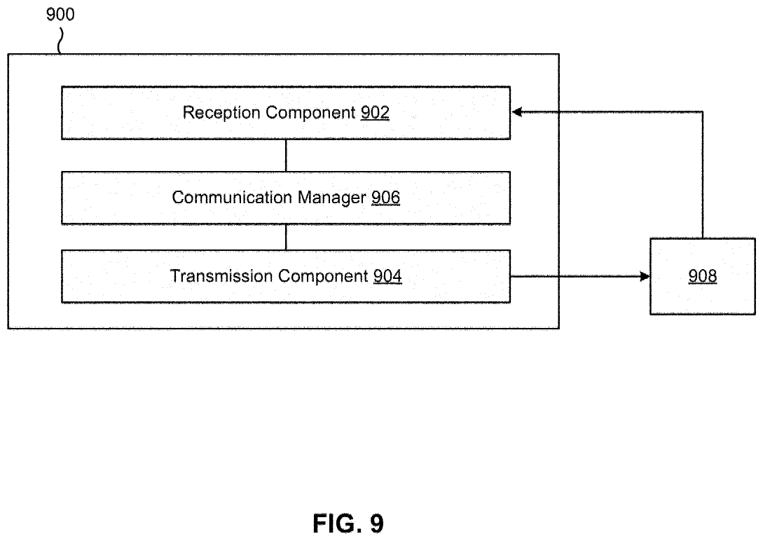

As shown in FIG. 8, in some aspects, process 800 may include receiving a configuration indicating a plurality of DL reference timings associated with TA management for a multiple transmission and reception point (mTRP) candidate cell (block 810). For example, the UE (e.g., using reception component 902 and/or communication manager 906, depicted in FIG. 9) may receive a configuration indicating a plurality of DL reference timings associated with TA management for a multiple transmission and reception point (mTRP) candidate cell, as described above.

As further shown in FIG. 8, in some aspects, process 800 may include deriving the plurality of DL reference timings based at least in part on the configuration (block 820). For example, the UE (e.g., using communication manager 906, depicted in FIG. 9) may derive the plurality of DL reference timings based at least in part on the configuration, as described above.

Process 800 may include additional aspects, such as any single aspect or any combination of aspects described below and/or in connection with one or more other processes described elsewhere herein.

In a first aspect, the configuration indicates a plurality of DL RS sets, wherein each DL reference timing of the plurality of DL reference timings corresponds to a respective DL RS set of the plurality of DL RS sets, each DL RS set of the plurality of DL RS sets being associated with a respective TRP of a plurality of TRPs associated with the mTRP candidate cell.

In a second aspect, alone or in combination with the first aspect, the plurality of DL RS sets are configured via at least one of RRC signaling a MAC CE.

In a third aspect, alone or in combination with one or more of the first and second aspects, DL RS sets in the plurality of DL reference signal sets are grouped according to a predetermined rule.

In a fourth aspect, alone or in combination with one or more of the first through third aspects, a DL reference timing of the plurality of DL reference timings is derived based at least in part on a first arrival path or a strongest arrival path of a DL RS set from the plurality of DL RS sets.

In a fifth aspect, alone or in combination with one or more of the first through fourth aspects, the configuration indicates a plurality of indicated TCI states, wherein each DL reference timing of the plurality of DL reference timings corresponds to a respective indicated TCI state of the plurality of indicated TCI states, each indicated TCI state of the plurality of indicated TCI states being associated with a respective TRP of a plurality of TRPs associated with the mTRP candidate cell.

In a sixth aspect, alone or in combination with one or more of the first through fifth aspects, a DL reference timing of the plurality of DL reference timings is derived based at least in part on a first arrival path or a strongest arrival path of a QCL source RS of an indicated TCI state from the plurality of indicated TCI states.

In a seventh aspect, alone or in combination with one or more of the first through sixth aspects, the configuration indicates a plurality of activated TCI state sets, wherein each DL reference timing of the plurality of DL reference timings corresponds to a respective activated TCI state set of the plurality activated TCI state sets, each activated TCI state set of the plurality of activated TCI state sets being associated with a respective TRP of a plurality of TRPs associated with the mTRP candidate cell.

In an eighth aspect, alone or in combination with one or more of the first through seventh aspects, a DL reference timing of the plurality of DL reference timings is derived based at least in part on a first arrival path or a strongest arrival path of one or more QCL source RSs of an activated TCI state set from the plurality of activated TCI state sets.

In a ninth aspect, alone or in combination with one or more of the first through eighth aspects, process 800 includes maintaining at least one DL reference timing of the plurality of DL reference timings.

In a tenth aspect, alone or in combination with one or more of the first through ninth aspects, the at least one DL reference timing is maintained based at least in part on an explicit indication to maintain the at least one DL reference timing.

In an eleventh aspect, alone or in combination with one or more of the first through tenth aspects, the explicit indication is received via at least one of RRC signaling, a MAC CE, or DCI.

In a twelfth aspect, alone or in combination with one or more of the first through eleventh aspects, the at least one DL reference timing is maintained based at least in part on an implicit indication to maintain the at least one DL reference timing.

In a thirteenth aspect, alone or in combination with one or more of the first through twelfth aspects, the at least one DL reference timing includes a DL reference timing associated with a default TRP.

In a fourteenth aspect, alone or in combination with one or more of the first through thirteenth aspects, process 800 includes transmitting UE capability information indicating a capability of the UE with respect to maintaining one DL reference timing or maintaining multiple DL reference timings.

In a fifteenth aspect, alone or in combination with one or more of the first through fourteenth aspects, the UE capability information is indicated per serving cell, per frequency band, or per frequency band combination.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive a configuration indicating a plurality of DL reference timings associated with TA management for a multiple transmission and reception point (mTRP) candidate cell. The communication manager 906 may derive the plurality of DL reference timings based at least in part on the configuration.

The communication manager 906 may maintain at least one DL reference timing of the plurality of DL reference timings.

The transmission component 904 may transmit UE capability information indicating a capability of the UE with respect to maintaining one DL reference timing or maintaining multiple DL reference timings.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components.

Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving a configuration indicating a plurality of downlink (DL) reference timings associated with timing advance (TA) management for a multiple transmission and reception point (mTRP) candidate cell; and deriving the plurality of DL reference timings based at least in part on the configuration.

Aspect 2: The method of Aspect 1, wherein the configuration indicates a plurality of DL reference signal (RS) sets, wherein each DL reference timing of the plurality of DL reference timings corresponds to a respective DL RS set of the plurality of DL RS sets, each DL RS set of the plurality of DL RS sets being associated with a respective TRP of a plurality of TRPs associated with the mTRP candidate cell.

Aspect 3: The method of Aspect 2, wherein the plurality of DL RS sets are configured via at least one of radio resource control (RRC) signaling a medium access control (MAC) control element (CE).

Aspect 4: The method of Aspect 2, wherein DL RS sets in the plurality of DL reference signal sets are grouped according to a predetermined rule.

Aspect 5: The method of Aspect 2, wherein a DL reference timing of the plurality of DL reference timings is derived based at least in part on a first arrival path or a strongest arrival path of a DL RS set from the plurality of DL RS sets.

Aspect 6: The method of any of Aspects 1-5, wherein the configuration indicates a plurality of indicated transmission configuration indicator (TCI) states, wherein each DL reference timing of the plurality of DL reference timings corresponds to a respective indicated TCI state of the plurality of indicated TCI states, each indicated TCI state of the plurality of indicated TCI states being associated with a respective TRP of a plurality of TRPs associated with the mTRP candidate cell.

Aspect 7: The method of Aspect 6, wherein a DL reference timing of the plurality of DL reference timings is derived based at least in part on a first arrival path or a strongest arrival path of a quasi co-location (QCL) source reference signal (RS) of an indicated TCI state from the plurality of indicated TCI states.

Aspect 8: The method of any of Aspects 1-7, wherein the configuration indicates a plurality of activated transmission configuration indicator (TCI) state sets, wherein each DL reference timing of the plurality of DL reference timings corresponds to a respective activated TCI state set of the plurality activated TCI state sets, each activated TCI state set of the plurality of activated TCI state sets being associated with a respective TRP of a plurality of TRPs associated with the mTRP candidate cell.

Aspect 9: The method of Aspect 8, wherein a DL reference timing of the plurality of DL reference timings is derived based at least in part on a first arrival path or a strongest arrival path of one or more quasi co-location (QCL) source reference signals (RSs) of an activated TCI state set from the plurality of activated TCI state sets.

Aspect 10: The method of any of Aspects 1-9, further comprising maintaining at least one DL reference timing of the plurality of DL reference timings.

Aspect 11: The method of Aspect 10, wherein the at least one DL reference timing is maintained based at least in part on an explicit indication to maintain the at least one DL reference timing.

Aspect 12: The method of Aspect 11, wherein the explicit indication is received via at least one of radio resource control (RRC) signaling, a medium access control (MAC) control element (CE), or downlink control information (DCI).

Aspect 13: The method of Aspect 10, wherein the at least one DL reference timing is maintained based at least in part on an implicit indication to maintain the at least one DL reference timing.

Aspect 14: The method of Aspect 13, wherein the at least one DL reference timing includes a DL reference timing associated with a default TRP.

Aspect 15: The method of any of Aspects 1-14, further comprising transmitting UE capability information indicating a capability of the UE with respect to maintaining one DL reference timing or maintaining multiple DL reference timings.

Aspect 16: The method of Aspect 15, wherein the UE capability information is indicated per serving cell, per frequency band, or per frequency band combination.

Aspect 17: An apparatus for wireless communication at a device, comprising a processor; memory coupled with the processor; and instructions stored in the memory and executable by the processor to cause the apparatus to perform the method of one or more of Aspects 1-16.

Aspect 18: A device for wireless communication, comprising a memory and one or more processors coupled to the memory, the one or more processors configured to perform the method of one or more of Aspects 1-16.

Aspect 19: An apparatus for wireless communication, comprising at least one means for performing the method of one or more of Aspects 1-16.

Aspect 20: A non-transitory computer-readable medium storing code for wireless communication, the code comprising instructions executable by a processor to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive a configuration indicating a plurality of downlink (DL) reference timings associated with timing advance (TA) management for a multiple transmission and reception point (mTRP) candidate cell; and
derive the plurality of DL reference timings based at least in part on the configuration.

2. The UE of claim 1, wherein the configuration indicates a plurality of DL reference signal (RS) sets, wherein each DL reference timing of the plurality of DL reference timings corresponds to a respective DL RS set of the plurality of DL RS sets, each DL RS set of the plurality of DL RS sets being associated with a respective TRP of a plurality of TRPs associated with the mTRP candidate cell.

3. The UE of claim 2, wherein the plurality of DL RS sets are configured via at least one of radio resource control (RRC) signaling a medium access control (MAC) control element (CE).

4. The UE of claim 2, wherein DL RS sets in the plurality of DL reference signal sets are grouped according to a predetermined rule.

5. The UE of claim 2, wherein a DL reference timing of the plurality of DL reference timings is derived based at least in part on a first arrival path or a strongest arrival path of a DL RS set from the plurality of DL RS sets.

6. The UE of claim 1, wherein the configuration indicates a plurality of indicated transmission configuration indicator (TCI) states, wherein each DL reference timing of the plurality of DL reference timings corresponds to a respective indicated TCI state of the plurality of indicated TCI states, each indicated TCI state of the plurality of indicated TCI states being associated with a respective TRP of a plurality of TRPs associated with the mTRP candidate cell.

7. The UE of claim 6, wherein a DL reference timing of the plurality of DL reference timings is derived based at least in part on a first arrival path or a strongest arrival path of aquasi co-location (QCL) source reference signal (RS) of an indicated TCI state from the plurality of indicated TCI states.

8. The UE of claim 1, wherein the configuration indicates a plurality of activated transmission configuration indicator (TCI) state sets, wherein each DL reference timing of the plurality of DL reference timings corresponds to a respective activated TCI state set of the plurality activated TCI state sets, each activated TCI state set of the plurality of activated TCI state sets being associated with a respective TRP of a plurality of TRPs associated with the mTRP candidate cell.

9. The UE of claim 8, wherein a DL reference timing of the plurality of DL reference timings is derived based at least in part on a first arrival path or a strongest arrival path of one or more quasi co-location (QCL) source reference signals (RSs) of an activated TCI state set from the plurality of activated TCI state sets.

10. The UE of claim 1, wherein the one or more processors are further configured to maintain at least one DL reference timing of the plurality of DL reference timings.

11. The UE of claim 10, wherein the at least one DL reference timing is maintained based at least in part on an explicit indication to maintain the at least one DL reference timing.

12. The UE of claim 11, wherein the explicit indication is received via at least one of radio resource control (RRC) signaling, a medium access control (MAC) control element (CE), or downlink control information (DCI).

13. The UE of claim 10, wherein the at least one DL reference timing is maintained based at least in part on an implicit indication to maintain the at least one DL reference timing.

14. The UE of claim 13, wherein the at least one DL reference timing includes a DL reference timing associated with a default TRP.

15. The UE of claim 1, wherein the one or more processors are further configured to transmit UE capability information indicating a capability of the UE with respect to maintaining one DL reference timing or maintaining multiple DL reference timings.

16. The UE of claim 15, wherein the UE capability information is indicated per serving cell, per frequency band, or per frequency band combination.

17. A method of wireless communication performed by a user equipment (UE), comprising:
receiving a configuration indicating a plurality of downlink (DL) reference timings associated with timing advance (TA) management for a multiple transmission and reception point (mTRP) candidate cell; and
deriving the plurality of DL reference timings based at least in part on the configuration.

18. The method of claim 17, wherein the configuration indicates a plurality of DL reference signal (RS) sets, wherein each DL reference timing of the plurality of DL reference timings corresponds to a respective DL RS set of the plurality of DL RS sets, each DL RS set of the plurality of DL RS sets being associated with a respective TRP of a plurality of TRPs associated with the mTRP candidate cell.

19. The method of claim 18, wherein the plurality of DL RS sets are configured via at least one of radio resource control (RRC) signaling a medium access control (MAC) control element (CE).

20. The method of claim 18, wherein DL RS sets in the plurality of DL reference signal sets are grouped according to a predetermined rule.

21-30. (canceled)
